(19) United States
(12) Patent Application Publication
(10) Pub. No.: US 2002/0020433 A1
(43) Pub. Date: Feb. 21, 2002

(54) Oxidation apparatus and method of cleaning the same

(76) Inventors: Asami Suemura, Nirasaki-Shi (JP); Kimiya Aoki, Tokyo-To (JP)

Correspondence Address: Smith, Gambrell & Russell, LLP, Beveridge, DeGrandi, Weilacher & Young,, Intellectual Property Group, 1850 M Street, N.W., Suite 800, Washington, DC, 20036, US

(21) Appl. No.: 09/748,109

(22) Filed: Dec. 27, 2000

(30) Foreign Application Priority Data
Dec. 28, 1999 (JP) 1999-373924

(51) Int. Cl. B08B 3/00; C02F 1/72; B08B 7/04

(52) U.S. Cl. 134/2; 210/198.1; 210/758; 134/26; 134/30; 134/34

(57) ABSTRACT

A cleaning method cleans a reaction tube and dummy wafers by removing therefrom tungsten and tungsten compound deposited on the inner surface of the reaction tube and the surfaces of the dummy wafer in a process of selectively oxidizing the side walls of a silicon layer included in an electrode of a layered structure consisting of a polysilicon layer and a tungsten layer. The interior of the reaction tube is heated, and a cleaning gas containing hydrogen chloride gas and oxygen gas is supplied through a cleaning gas supply port into the reaction tube to remove the tungsten and the tungsten compound adhering to the inner surface of the reaction tube and the surfaces of the dummy wafers.

### BACKGROUND OF THE INVENTION

1. Field of the Invention

The present invention relates to an oxidation system capable of cleaning function and a method of cleaning the oxidation system.

2. Description of the Related Art

A previously proposed MOS transistor of a MOS structure, which is stable under heat and has low gate resistance, has a polysilicon-metal electrode of a layered structure of polysilicon layer 101 and a metal layer 103 as shown in FIG. 5A.

The MOS transistor having the Si-metal electrode is fabricated by the following process. A gate oxide film 105, a polysilicon layer 101, a tungsten nitride layer 113, a tungsten layer 103 and a silicon nitride layer 111 are formed in that order on a silicon substrate 109. The silicon nitride layer 111, the tungsten layer 103, the tungsten nitride layer 113 and the polysilicon layer 101 are patterned sequentially to form an electrode structure shown in FIG. 5B.

The MOS transistor is placed in a processing vessel of a wet oxidation system, the respective partial pressures of steam and hydrogen gas are maintained at values in a shaded selective oxidation region shown in FIG. 6 for oxidation process to reduce stresses between the polysilicon layer 101 and the gate oxide film 105. A reaction expressed by Reaction formula (1) occurs in the selective oxidation process and the side walls of the polysilicon layer 101 are oxidized. The tungsten layer 103 is oxidized by a chemical reaction expressed by Reaction formula (2) and is reduced by a chemical reaction expressed by Reaction formula (3). Therefore, a side wall oxide film 107 is formed only on the side walls of the polysilicon layer 101. The side wall oxide film 107 reduces stresses between the polysilicon layer 101 and the gate oxide film 105.

Si+2H₂O→SiO₂+2H₂ (1)

W+3H₂O→WO₃+3H₂ (2)

W+3H₂O←WO₃+3H₂ (3)

Subsequently, impurity ions are implanted through the gate oxide film 105 in the silicon substrate 109 by an ion implantation process using the gate electrode (101, 113 and 103) and the side wall oxide film 107 as a mask to form a source region S and a drain region D by a self-aligned process.

Recently, the selective oxidation techniques have been applied to commercial oxidation systems for mass production. During the course of development of a commercial oxidation system for mass production, the inventors of the present invention were encountered by a problem that parts of an oxide film formed on a peripheral part and a central part of a wafer, respectively, differ from each other in thickness. Laboratory activities for the development of selective oxidation techniques have not been encountered by such a problem.

### SUMMARY OF THE INVENTION

The present invention has been made to solve the aforesaid problem. Results of analysis of the aforesaid problem made by the inventors of the present invention will be explained.

Whereas a laboratory oxidation system usually is of a single-wafer processing type, a commercial oxidation system is of a batch processing type, because the commercial oxidation system must operate at a high throughput and it is preferable and efficient to process a plurality of wafers simultaneously. Moreover, a commercial oxidation system of a batch processing type differs from a laboratory system of a single-wafer processing type in the fact that: a plurality of wafers held at relatively small intervals when they are subjected to processing; and in the fact that some dummy wafers are mounted on a wafer boat to avoid subjecting a plurality of wafers, which are held on the wafer boat in the above-mentioned manner, to different process conditions. The dummy wafers are used repeatedly because they are expensive.

The inventors of the present invention noticed such differences between the laboratory oxidation system and the commercial oxidation system, studied the causes of formation of films of irregular thickness, and came to the following conclusion.

The inventors concluded that the first reason for the formation of films of irregular thickness is resulted from the fact that, due to the small intervals of the wafers processed by a batch type processing system, steam is able to spread satisfactorily over peripheral parts of the wafers but is unable to spread satisfactorily over central parts of the wafers. Although tungsten is a relatively stable substance, part of tungsten is vaporized in an oxidation process that is carried out in an atmosphere of a high temperature and a reduced pressure. Tungsten vapor and steam interact directly and a chemical reaction expressed by Reaction formula (4) occurs.

W+4H₂O(g)→H₂WO₄(g)+3H₂ (4)

Steam is consumed by the chemical reaction in vicinity of peripheral parts of the wafers and steam has difficulty in flowing to central parts of the wafers. Consequently, an oxide film formed on each wafer has a central part corresponding to a central part of the wafer and having a thickness smaller than that of a peripheral part corresponding to a peripheral part of the wafer. Moreover, WO₃ produced by the chemical reaction expressed by Reaction formula (2) reacts with steam to cause a chemical reaction expressed by Reaction formula (5), which consumes steam and makes it difficult for steam to each the central parts of the wafers. Consequently, an oxide film formed on each wafer has a central part corresponding to a central part of the wafer and having a thickness smaller than that of a peripheral part corresponding to a peripheral part of the wafer.

WO₃+H₂O(g)→H₂WO₄(g) (5)

However, there arose a problem that cannot be attributed to the narrow spacing of the wafers. The problem was that the uniformity of the oxide film thickness deteriorates as the number of processing cycles increases. The inventors inferred from this fact that it is possible that some substance that consumes steam is deposited on the dummy wafers and the inner surface of a reaction tube in which the wafers are processed. Finally, the inventors concluded that tungsten vapor diffuses in the reaction tube and deposits on the dummy wafers and the inner surface of the reaction tube, H₂WO₄ gas (WO₃·H₂O: tetraoxotungsten acid gas) produced by the chemical reactions expressed by Reaction formulas (4) and (5) is dissolved in steam and diffuses in the reaction tube and deposits on the dummy wafers and the inner surface of the reaction tube, the deposit diffuses during the oxidation process and reacts with steam, so that steam has difficulty in reaching the central parts of the wafers.

Thus the inventors found that the cleaning of the reaction tube and the dummy wafers, which had been thought to be unnecessary for the oxidation system, is essential to the commercial oxidation system for mass production and have made the present invention. The present invention provides a novel oxidation system provided with a cleaning means and a method of operating the oxidation system.

According to a first aspect of the present invention, an oxidation system is provided. The system includes: a reaction tube capable of accommodating an object to be processed, a heater for heating the interior of the reaction tube, a discharge line connected to the reaction tube to discharge an atmosphere in the reaction tube, an oxidation process gas supply line connected to the reaction tube to carry an oxidation process gas for oxidizing the object from an oxidation process gas source into the reaction tube, and a cleaning gas supply line connected to the reaction tube to carry an cleaning gas for cleaning the reaction tube of a metal and a metal compound adhering to the inner surface of the reaction tube from a cleaning gas source into the reaction tube.

According to a second aspect of the present invention, an oxidizing and cleaning method is provided. The method includes the steps of: (a) placing an object to be processed, which is provided with a silicon layer and a metal layer, in a reaction tube; (b) supplying an oxidation process gas into the reaction tube, thereby selectively oxidizing the silicon layer of the object placed in the reaction tube; (c) taking out the object from the reaction tube after the completion of the step (b); and (d) supplying a cleaning gas into the reaction tube after the object has been removed therefrom, thereby making the cleaning gas react with a metal or a metal compound deposited on a inner surface of the reaction tube in order to remove the metal or the metal compound therefrom, wherein the metal or the metal compound has been produced from a substance separated from the metal layer of the object and has been deposited in the step (b).

The metal or the metal compound deposited on the reaction tube can be relatively easily removed by supplying the cleaning gas into the reaction tube of the oxidation system. Thus reduction of oxidation ability and film thickness irregularity due to the metal or the metal compound deposition on the reaction tube can be suppressed.

Generally, dummy wafers are used in the oxidation process when the oxidation system is of a batch processing type. It is preferable to clean the dummy wafers simultaneously with the cleaning of the reaction tube because the metal or the metal compound is deposited also on the dummy wafers. It is preferable to clean quartz-jigs, e.g., a wafer boat (i.e., a holder for supporting objects to be processed) simultaneously with the cleaning of the reaction tube because the metal or the metal compound is deposited also on the quartz jigs.

The cleaning gas may be a gas including a compound gas containing at least chlorine or fluorine. If the cleaning gas is a compound gas containing chlorine, it is preferable to mix oxygen gas in the cleaning gas. Addition of oxygen gas to the cleaning gas improves cleaning efficiency.

The oxidation process gas may be a gas containing steam and hydrogen gas. When such an oxidation process gas is used, the respective partial pressures of steam and hydrogen gas contained in the oxidation process gas in the reaction tube, and the temperature of the oxidation process gas are controlled so that the silicon layer is oxidized and the oxidation of the metal layer is suppressed.

### BRIEF DESCRIPTION OF THE DRAWINGS

FIG. 1 is a perspective view of a reaction tube, a wafer boat and a wafer boat elevator included in a vertical oxidation system according to the present invention;

FIG. 2 is a diagrammatic view illustrating the general configuration of a vertical oxidation system;

FIG. 3 is a diagram of assistance in explaining a cleaning procedure for cleaning the vertical oxidation system shown in FIG. 1;

FIG. 4 is a graph showing the distribution of tungsten concentration on a dummy wafer in a state before cleaning and a state after cleaning;

FIGS. 5A and 5B are typical sectional views of assistance in explaining a silicon-tungsten electrode and a method of forming the same;

FIG. 6 is a graph showing the dependence of the respective states of silicon and tungsten on the temperature of an oxidation process gas and the steam/hydrogen partial pressure ratio between steam and hydrogen gas contained in the oxidation process gas; and

FIG. 7 is a diagrammatic view illustrating the general configuration of a vertical oxidation system in a modification of the vertical oxidation system shown in FIG. 2.

### DESCRIPTION OF THE PREFERRED EMBODIMENTS

Preferred embodiments of the present invention will be described with reference to the accompanying drawings.

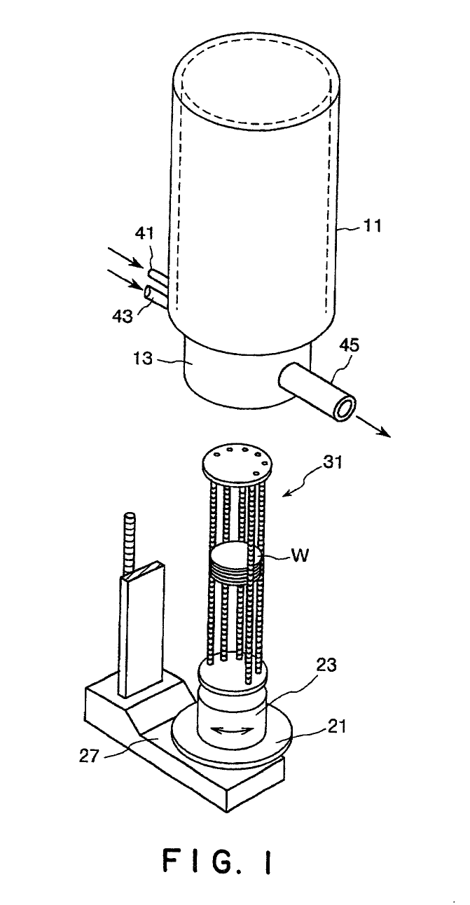

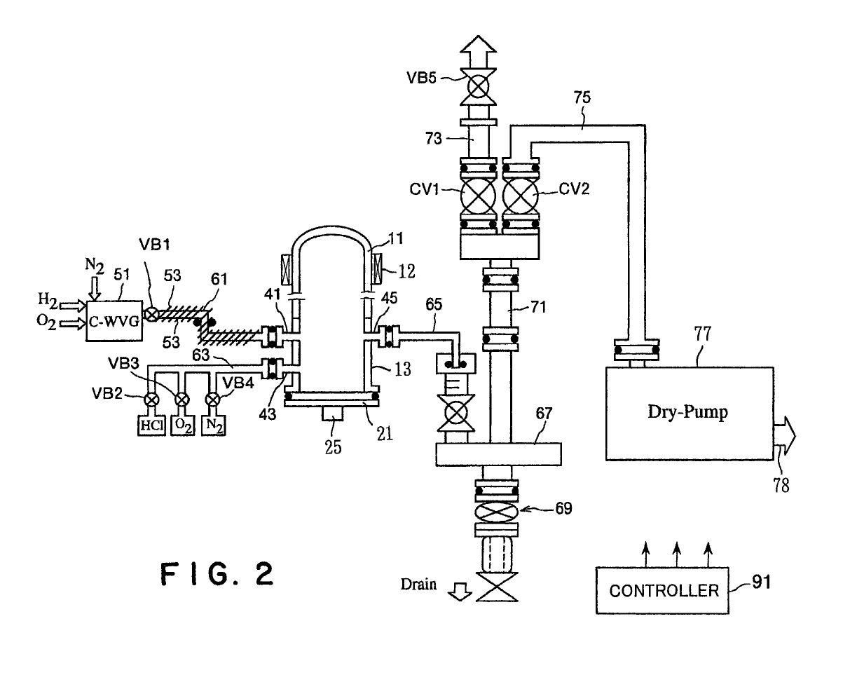

FIG. 1 shows a reaction tube and associated components included in a vertical oxidation system according to the present invention. The vertical oxidation system has a cylindrical reaction tube 11. The tube 11 has a top wall, and the longitudinal axis of the tube 11 is extends vertically. The reaction tube 11 is formed of a refractory material, such as quartz. The reaction tube 11 is a double-tube structure consisting of an outer tube and an inner tube, however, it may be a single-tube structure. A heater 12 (FIG. 2) capable of rapidly heating the interior of the reaction tube 11 surrounds the reaction tube 11.

A manifold 13 of a stainless steel is disposed under the reaction tube 11. The reaction tube 11 may be formed of SiO₂ or SiC. A oxidation process gas supply port 41 and a cleaning gas supply port 43 are formed in one side part of the manifold 13, and a discharge port 45 is formed in the other side part of the manifold 13.

A disk-shaped cover 21 is disposed below the manifold 13. The cover 21 is capable of sealing the reaction tube 11 in an airtight fashion. A heat insulating tube 23 is mounted on the cover 21. A wafer boat 31 can be placed on the heat insulating tube 23. The heat insulating tube 23 is connected to a shaft 25 (FIG. 2). The cover 21 is attached to a boat elevator 27 capable of vertical movement. The shaft 25 is rotated by a rotative driving device (not shown) installed in the boat elevator 27 to rotate the heat insulating tube 23 and the wafer boat 31 mounted on the heat insulating tube 23.

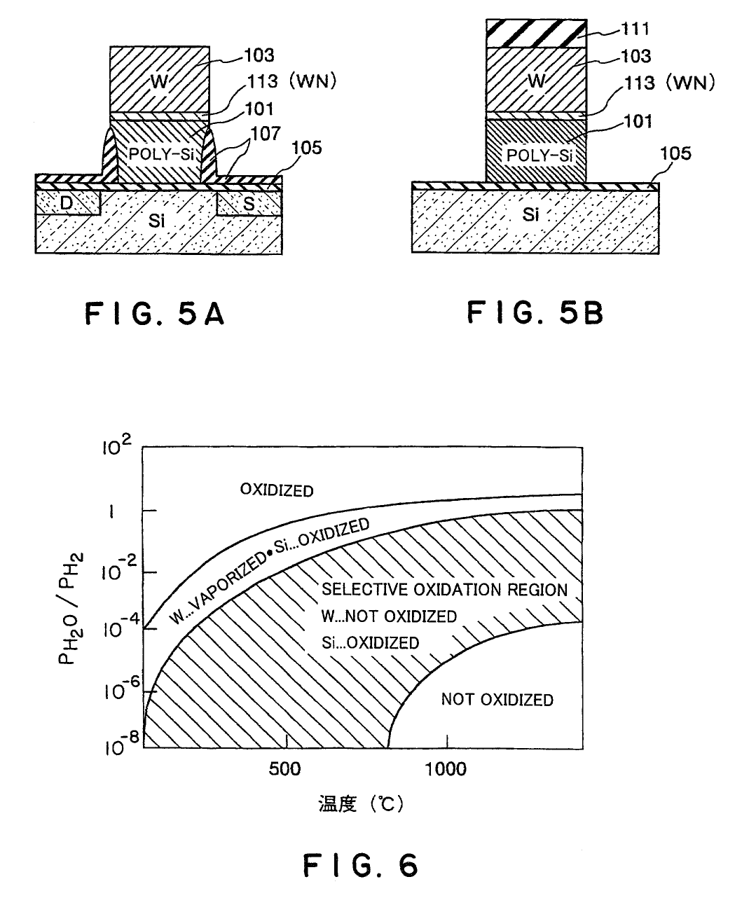

The wafer boat 31 (thermal treatment boat), i.e., an object holder, is capable of holding a plurality of wafers W, i.e., semiconductor substrates, at predetermined vertical intervals. MOS transistors having an electrode structure shown in FIG. 5A are formed on the wafers W. The boat elevator 27 is raised to carry the wafer boat 31 into the reaction tube 11 and is lowered to carry the wafer boat 31 out of the reaction tube 11.

FIG. 2 shows the whole construction of the oxidation system. The oxidation process gas supply port 41 of the manifold 13 is connected to a steam generator 51 by an oxidation process gas supply pipe 61 provided with a valve VB1. Gas sources (not shown) supply hydrogen gas (H₂), oxygen gas (O₂) and nitrogen gas (N₂) to the steam generator 51. The steam generator 51 generates steam by a catalytic reaction of hydrogen gas with oxygen gas. Hydrogen gas and generated steam are supplied into the reaction tube 11 by using nitrogen gas as a carrier. The steam generator 51 may be such as generates steam by a combustion reaction of oxygen gas with hydrogen gas. The oxidation process gas supply pipe 61 is surrounded by a heater 53 to prevent the condensation of steam in the oxidation process gas supply pipe 61.

A cleaning gas supply pipe 63 is connected to the cleaning gas supply port 43. The cleaning gas supply pipe 63 is connected through valves VB2, VB3 and VB4 to a chlorine gas source (HCl source), an oxygen gas source and a nitrogen gas source, respectively.

A discharge pipe 65 is connected to the discharge port 45 of the manifold 13. The discharge pipe 65 is connected through a valve to a duct 67. Connected to the duct 67A are a drain line 69 for draining water produced by the condensation of steam and a discharge pipe 71.

The discharge pipe 71 branches into an atmospheric discharge pipe 73 (in fact, it is in a slight vacuum) and a vacuum discharge pipe 75. The discharge pipe 73 is connected through a valve VB5 to a plant-acid-vapor exhaust system (not shown) to discharge gases produced by a cleaning process, such as a halogen gas used for the cleaning process, through the discharge pipe 73. The vacuum discharge pipe 75 is connected to a vacuum pump 77. The vacuum pump 77 as used in this embodiment is a dry pump having a discharge capacity in the range of about 15000 to about 20000 l/min. A discharge pipe 78 connected to the vacuum pump 77 is connected to a plant exhaust system (not shown) to discharge gases containing water produced by the oxidation process.

Compound-function valves CV1 and CV2 are connected to inlet ends of the discharge pipes 73 and 75, respectively. The compound-function valve is not only fully opened and closed but also can be adjusted to a desired opening. The compound-function valve has a valve body, a valve controller and a pressure sensor, which are not shown in FIG. 2. The valve controller adjusts valve opening so that pressure measured by the pressure sensor is adjusted to a predetermined value. The pressure in the reaction tube 11 can be adjusted to a slight vacuum in the range of 0 to −1000 Pa with respect to the atmospheric pressure (i.e., the atmospheric pressure to a pressure lower than the atmospheric pressure by 1000 Pa) by the cooperation of the plant exhaust system and the compound-function valve CV1. The pressure in the reaction tube 11 can be adjusted to a pressure in the range of 133 Pa to 101 kPa (1 to 760 Torr) by the cooperative actions of the vacuum pump 77 and the compound-function valve CV2.

Preferably, parts of the discharge pipes 65, 71 and 75 and the duct 67 through which hydrogen chloride flows are formed of quartz or Teflon, or are metal pipes lined with Teflon and a duct formed from metal plates lined with Teflon.

The steam generator 51, the valves VB1 to VB5, the boat elevator 27 and the vacuum pump 77 are connected to a controller 91. Sensors measures temperatures and pressures in the components of the vertical oxidation system and the controller 91 gives control signals to those component devices to carry out the automatic control of the following series of processes on the basis of the measured temperatures and pressures.

The operation of the vertical oxidation system as applied to the selective oxidation of the side walls of the polysilicon layer 101 forming the gate electrode of the MOS transistor shown in FIG. 5B will be described. The series of processes are controlled automatically by the controller 91.

Wafers W to be processed are loaded on the wafer boat 31 and dummy wafers are placed at proper positions in the wafer boat 31. The wafer boat 31 thus loaded with the wafers W is mounted on the heat insulating tube 23, the boat elevator 27 is raised to load the wafer boat 31 into the reaction tube 11.

After an operation for loading the wafer boat 31 into the reaction tube 11 has been accomplished and the cover 21 has been closely joined to the manifold 13, the compound-function valve CV1 is fully closed and the vacuum pump 77 is actuated. The opening of the compound-function valve CV2 is controlled to evacuate the reaction tube 11 slowly so that the wafers W may not be disturbed and reaction products deposited in the reaction tube 11 may be stirred up. Thus the reaction tube 11 is evacuated to a predetermined pressure, such as 10 Torr. Meanwhile, the interior of the reaction tube 11 is heated at a temperature in the range of about 600 to about 1000° C. by the heater 12.

After the reaction tube 11 has been evacuated to a predetermined pressure and the interior of the reaction tube 11 has been heated to a predetermined temperature, an operation for supplying hydrogen gas and oxygen gas into the steam generator is started and the valve VB1 is opened. A catalytic reaction between hydrogen and oxygen occurs in the steam generator 51 to produce hydrogen gas containing steam. The hydrogen gas containing steam is carried by nitrogen gas, i.e., a carrier gas, through the oxidation process gas supply pipe 61 into the reaction tube 11. The oxidation process gas supply pipe 61 is heated by the heater 53 to prevent the condensation of steam in the oxidation process gas supply pipe 61.

The opening of the compound-function valve CV2 is controlled so as to maintain the pressure in the reaction tube 11 at a pressure in the range of about 25 to about 50 Torr during evacuation and the supply of the oxidation process gas is continued for a predetermined period. During this period, the temperature of steam and hydrogen gas and the steam/hydrogen partial pressure ratio between steam and hydrogen gas are controlled so that the relation between the temperature of steam and hydrogen gas and the steam/hydrogen partial pressure ratio lies in a shaded region in FIG. 6. Thus, only the side walls of the silicon layer 101 of the electrode structure shown in FIG. 5B are oxidized selectively and the tungsten layer 103 is substantially not oxidized. The steam/hydrogen partial pressure ratio, the temperatures and the pressures are measured continuously by the sensors and are controlled continuously so as to coincide with desired values, respectively.

During this wet oxidation process, the used gas is discharged through the discharge pipe 78 into the plant exhaust system by the vacuum pump 77.

After the completion of the oxidation process, the steam generator 51 is stopped, the valve VB1 is closed, a purge gas is supplied into the reaction tube 11 and the interior of the reaction tube 11 is set at an atmospheric pressure. Subsequently, the heater 12 is stopped and the reaction tube 11 is left cooling for a predetermined time.

After the reaction tube 11 has been cooled, the boat elevator 27 is lowered to take out the wafer boat 31 from the reaction tube 11. The wafer boat 31 loaded with the wafers W is removed from the boat elevator 27 and the wafers W are transferred from the wafer boat 31 to a wafer cassette. The dummy wafers are left on the wafer boat 31 for the next cycle of the oxidation process. The dummy wafers may be put in another cassette and the cassette containing the dummy wafers may be carried to and stored in a cassette storage to use the same when necessary.

Thus, one cycle of the oxidation process for processing one batch of wafers is accomplished.

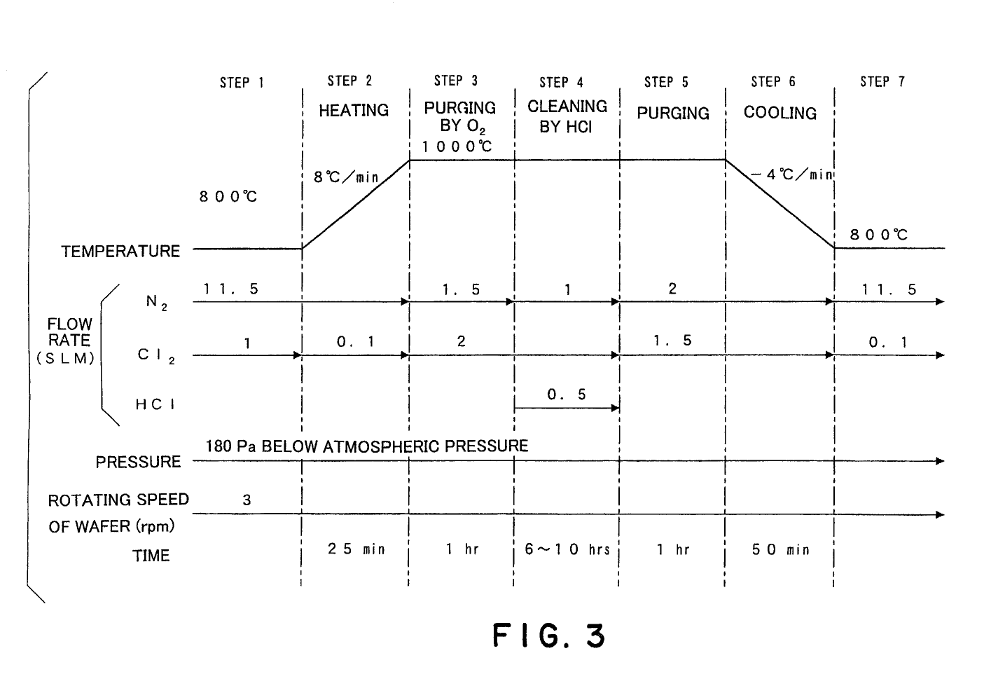

As mentioned above, the tungsten vapor and reaction by-products including WO₃ are deposited on the reaction tube 11, the manifold 13, the wafer boat 31 and the dummy wafer as the oxidation process is repeated. Tungsten and WO₃ thus deposited consumes steam in the next cycle of the oxidation process causing the formation of an oxide film of an irregular thickness. The oxidation system is cleaned periodically or when necessary by a cleaning process to solve such a problem. The cleaning process will be described with reference to FIG. 3.

The wafer boat 31 holding the dummy wafers is mounted on the heat insulating tube 23 and the cover 21 is joined closely to the manifold 13 in an airtight fashion. Then, the compound-function valve CV2 is fully closed. The opening of the compound-function valve CV1 is controlled to adjust the pressure in the reaction tube 11 to a pressure lower than the atmospheric pressure by a pressure in the range of about 100 to about 300 Pa, for example, by 180 Pa.

The interior of the reaction tube 11 is heated at a temperature in the range of 600 to 900° C., preferably, at about 800° C. by the heater 12. Then, the valves VB4 and VB3 are opened to supply nitrogen gas at 11.5 SLM and oxygen gas at a flow rate in the range of 0.3 to 3 SLM, preferably at about 1 SLM into the reaction tube 11. The shaft 25 is driven to rotate the heat insulating tube 23 at about 3 rpm (Step 1).

Subsequently, the temperature of the interior of the reaction tube 11 is raised at a heating rate in the range of 5 to 10° C./min, preferably, at about 8° C./min by the heater 12. Meanwhile, the flow rate of oxygen gas decreased to a flow rate in the range of 0.05 to 1 SLM, preferably, about 0.1 SLM (Step 2).

After the interior of the reaction tube 11 has been heated to a temperature in the range of 950 to 1100° C., preferably, 1000° C., nitrogen gas and oxygen gas are supplied at 1.5 SLM and about 2 SLM, respectively, for about 1 hr to purge the reaction tube 11 (Step 3).

Subsequently, the valve VB2 is opened and HCl gas is supplied at a flow rate in the range of 0.1 to 3 SLM, preferably, at about 0.5 SLM. Meanwhile, oxygen gas and nitrogen gas are supplied at the flow rates mentioned in connection with Step 3. This state is maintained for a period in the range of 6 to 10 hr (Step 4). Cl atoms contained in HCl gas are activated by heat. The activated Cl atoms react with the tungsten and WO₃ deposited on the inner surface of the reaction tube 11 (the inner surfaces of the inner and the outer tube when the reaction tube 11 is a double-tube structure), the inner surface of the manifold 13 and the surfaces of the wafer boat 31 and the dummy wafers, whereby the tungsten and WO₃ are decomposed into gases. The oxygen gas promotes the decomposition of the tungsten and WO₃. The gases thus produced by the decomposition of the tungsten and WO₃ are discharged through the discharge port 45 and the discharge pipes 65, 71 and 73 into the plant exhaust system.

After the completion of Step 4, the supply of HCl gas is stopped and the reaction tube 11 is purged of the residual HCl gas by supplying nitrogen gas and oxygen gas into the reaction tube 11 for about 1 hr (Step 5).

After the completion of purging, the heater 12 is controlled to cool the reaction tube 11 gradually to about 800° C. in about 50 min at a cooling rate of, for example, 4° C./min (Step 6). Then, another process is started (Step 7).

The tungsten and the tungsten compound deposited on the inner surface of the reaction tube 11 and the surfaces of the wafer boat 31 and the dummy wafers can be removed without disassembling the oxidation system or without removing any parts of the oxidation system by the aforesaid cleaning procedure. Consequently, the reaction of the tungsten and WO₃ deposited on the inner surface of the reaction tube and the surfaces of the wafer boat 31 and the dummy wafers with steam during the oxidation process and the resulting adverse influence on the oxidation process can be prevented.

Since the dummy wafers are small and easy to handle as compared with the reaction tube 11 and the wafer boat 31, the dummy wafers may be separated from the reaction tube 11 and the wafer boat 31, and they may be cleaned by a wet cleaning process.

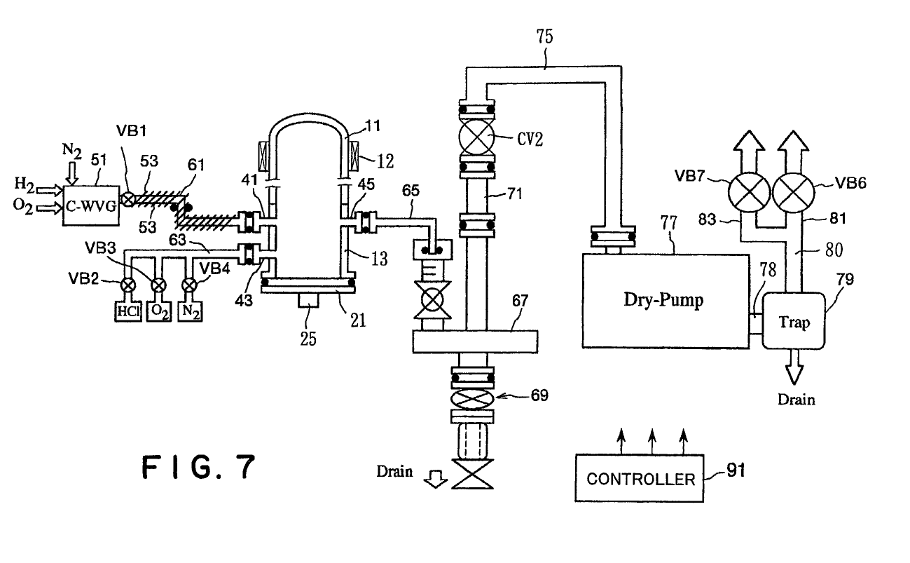

The construction of the oxidation system may be modified as shown in FIG. 7. The oxidation system shown in FIG. 7 has a discharge system different from that of the vertical oxidation system shown in FIG. 2 and is identical in other respects with the latter. In FIG. 7, parts like or corresponding to those shown in FIG. 2 are denoted by the same reference characters.

Referring to FIG. 7, the oxidation system is not provided with any pipe corresponding to the discharge pipe 73. All the waste gases discharged from a reaction tube 11 during an oxidation process are sucked by a vacuum pump 77. A discharge pipe 78 connected to the vacuum pump 77 is provided with a trap 79. A discharge pipe 80 is connected to the outlet port of the trap 79. The discharge pipe 80 branches into two discharge pipes 81 and 83.

A waste gas produced by the oxidation process is discharged through the first discharge pipe 81 and a halogen gas used by a cleaning process is discharged through the second discharge pipe 83. The discharge pipes 81 and 83 are provided with valves VB6 and VB7, respectively. A waste gas discharged from the trap 79 is discharged through either the first discharge pipe 81 or the second discharge pipe 83. The first discharge pipe 81 is connected to a scrubber that makes the waste gas produced by the wet oxidation process harmless. The second discharge pipe 83 is connected to a scrubber that removes hydrogen chloride from the waste gas.

In the oxidation system shown in FIG. 7, the pressure in the reaction tube 11 and the flow rate of gases are controlled by the cooperation of the vacuum pump 77 and a compound-function valve CV2 for both the oxidation process and the cleaning process. The valves VB6 and VB7 are controlled by a controller 91.

In the oxidation process, the valve VB6 is opened and the valve VB7 is closed. Consequently, reaction products contained in the waste gas sucked from the reaction tube 11 by the vacuum pump 77 are removed by the trap 79, and the waste gas is scrubbed and made harmless by the scrubber connected to the first discharge pipe 81, and the harmless waste gas is discharged outside through the first discharge pipe 81. The oxidation system carries out the same oxidation process as that previously described in connection with the oxidation system shown in FIG. 2.

The oxidation system shown in FIG. 7 carries out a cleaning process that is different from that previously described in connection with the oxidation system shown in FIG. 2. The former oxidation system uses the vacuum pump 77 instead of the plant exhaust system to suck the atmosphere in the reaction tube 11. In the cleaning process, the valve VB6 is closed and the valve VB7 is opened. Consequently, reaction products contained in the waste gas sucked from the reaction tube 11 by the vacuum pump 77 are removed by the trap 79, and the waste gas is scrubbed and made harmless by the scrubber connected to the second discharge pipe 83, and the harmless waste gas is discharged outside through the second discharge pipe 83. The oxidation system carries out the same cleaning process as that previously described in connection with the oxidation system shown in FIG. 2. The range of allowable pressures in the reaction tube for the cleaning process is wider than that for the oxidation process. When the oxidation system shown in FIG. 7 carries out the cleaning process, the pressure in the reaction tube 11 may be in the range of 133 Pa to 101 kPa (1 to 760 Torr).

When cleaning the oxidation system shown in FIG. 7, the atmosphere in the reaction tube 11 is sucked by the vacuum pump 77, the allowable pressure range for the pressure in the reaction tube 11 is wide and hence the accuracy of pressure control can be improved. Since the waste gases produced by the oxidation process and the cleaning process are discharged through the separate discharge pipes 81 and 83 and the special scrubbers for the oxidation and the cleaning process, respectively, the potential of the oxidation system for environmental pollution can be reduced.

The wide allowable pressure range provides the following advantages. When the pressure in the reaction tube 11 is maintained substantially constant during Step 4 of the cleaning process, hydrogen chloride has difficulty in reaching parts having a low conductance and parts (dead spaces) in which the gas stagnates and deposited metals deposited in such parts are liable to remain unremoved. For example, the manifold 13 has many protrusions, recesses and joints and hence hydrogen chloride has difficulty in uniformly covering the manifold 13. Therefore, it is preferable to vary the pressure in the reaction tube 11 repeatedly. More concretely, it is preferable to vary the pressure in the reaction tube 11 in the predetermined range of, for example, about 1 to about 100 kPa by properly regulating the opening of the compound-function valve V2. The oxidation system shown in FIG. 7 is capable of easily achieving such a pressure variation.

The vacuum pump 77 of the oxidation system shown in FIG. 7 must be highly corrosion-resistant because an oxidizing gas flows through the vacuum pump 77 and hence the oxidation system is costly. Therefore, either the oxidation system shown in FIG. 2 or the oxidation system shown in FIG. 7 may be selectively used by weighing their merits against their demerits.

The object of the oxidation process is not limited to the polysilicon layer of the polysilicon-metal gate electrode as shown in FIG. 5A. The oxidation system is applicable to various oxidation processes for selectively oxidizing the polysilicon layer of an object including the polysilicon layer and a metal layer. The object of oxidation is not limited to a polysilicon layer, but may be a single-crystal silicon layer or an amorphous silicon layer. The metal layer is not limited to the tungsten layer, by may be a layer of a metal having a high melting point (refractory metal), such as tun titanium or molybdenum.

The cleaning gas is not limited to HCl, but may be a gas containing a halogen other than Cl, such as HF gas, ClF₃ gas, Cl₂ gas or NF₃ gas.

In the aforesaid embodiments, the cleaning process is performed with the dummy wafers supported on the wafer boat 31. The cleaning process may be performed with the wafers and the dummy wafers removed from the wafer boat 31 and only the wafer boat 31 mounted on the heat insulating tube 23.

[Experiments]

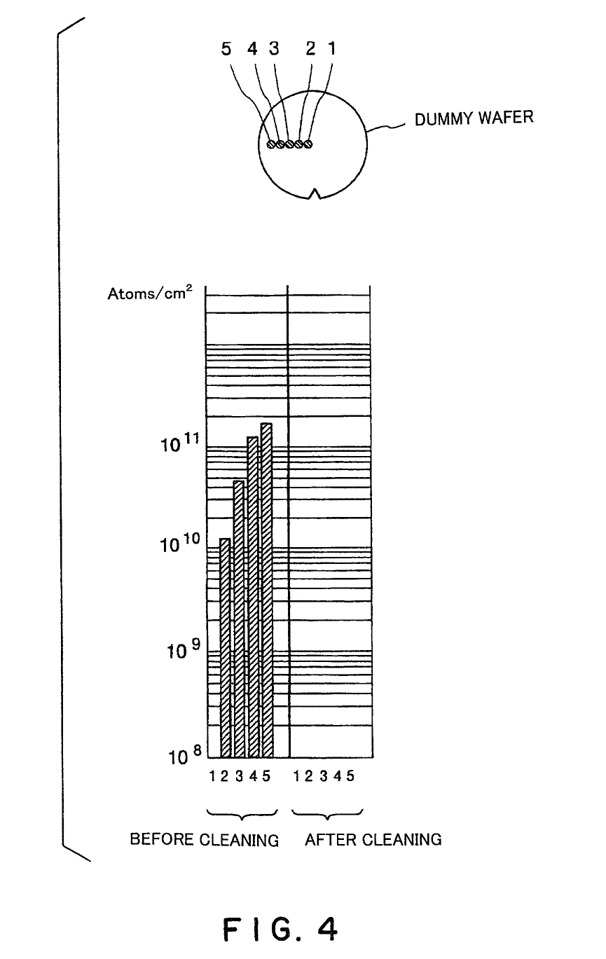

Experiments were conducted to verify the effect of the cleaning process. Dummy wafers used by the oxidation system shown in FIG. 1 for thirty cycles of a selective oxidation process were cleaned by the foregoing cleaning procedure for 6 hr. Tungsten concentration on the surfaces of the dummy wafers in a state before cleaning and a sate after cleaning was measured. Measured results are shown in FIG. 4.

Tungsten on the surface of the dummy wafer was detected in the state before cleaning. The tungsten concentration was the highest in a peripheral part of the dummy wafer and decreased gradually toward the central part of the dummy wafer. Tungsten concentrations at any parts on the dummy wafer were not higher than a tungsten detection limit of 10⁹/cm². The experiments proved that the use of HCl and oxygen in combination for cleaning is very effective in removing tungsten from the dummy wafers.

It was confirmed through the comparison of oxide films formed by using the cleaned oxidation system and the cleaned dummy wafers and those formed by using not cleaned oxidation system and the not cleaned dummy wafers that the intrasurface uniformity (intrawafer uniformity) of the former oxide films is higher than that of the latter oxide films.

The use of HCl gas in combination with oxygen gas for cleaning is more effective than the use of only HCl gas.

What is claimed is:

1. An oxidation system comprising:
a reaction tube capable of accommodating an object to be processed;
a heater that heats an interior of the reaction tube;
a discharge line connected to the reaction tube to discharge an atmosphere in the reaction tube;
an oxidation process gas supply line connected to the reaction tube to carry an oxidation process gas for oxidizing the object from an oxidation process gas source into the reaction tube; and
a cleaning gas supply line connected to the reaction tube to carry a cleaning gas for removing a metal and a metal compound deposited on an inner surface of the reaction tube from a cleaning gas source into the reaction tube to clean the reaction tube.

2. The oxidation system according to claim 1, wherein the object has a silicon layer and a metal layer,
said oxidation system further comprising:
an oxidation process gas source that supplies an oxidation process gas containing steam and hydrogen gas into the oxidation process gas supply line; and
a controller that controls the heater and the oxidation process gas supply source to control temperature of the oxidation process gas and partial pressure ratio between steam and hydrogen gas so that the silicon layer is oxidized and oxidation of the metal layer is suppressed.

3. The oxidation system according to claim 1, wherein the object has a silicon layer and a metal layer, the oxidation process gas contains steam and hydrogen, and the cleaning gas contains a compound gas containing at least chlorine or fluorine.

4. The oxidation system according to claim 3, wherein the silicon layer is formed of polysilicon, and the metal layer is formed of tungsten or a tungsten compound.

5. The oxidation system according to claim 1, wherein the object has a silicon layer and a metal layer, and the cleaning gas contains oxygen gas and a compound gas containing chlorine.

6. An oxidizing and cleaning method comprising the steps of:
(a) placing an object to be processed, which is provided with a silicon layer and a metal layer, in a reaction tube;
(b) supplying an oxidation process gas into the reaction tube, thereby selectively oxidizing the silicon layer of the object placed in the reaction tube;
(c) taking out the object from the reaction tube after the completion of the step (b); and
(d) supplying a cleaning gas into the reaction tube after the object has been removed therefrom, thereby making the cleaning gas react with a metal or a metal compound deposited on a inner surface of the reaction tube in order to remove the metal or the metal compound therefrom, wherein the metal or the metal compound has been produced from a substance separated from the metal layer of the object and has been deposited in the step (b).

7. The method according to claim 6, wherein the object is placed in the reaction tube while the object is held by a holder in the steps (a) and (b), and the object is removed from the holder in the step (c), said method further comprising the step of:
(e) placing the holder not holding any objects in the reaction tube before starting the step (d),
wherein a metal or a metal compound deposited on a surface of the holder is removed by using the cleaning gas in the step (d).

8. The method according to claim 7, wherein:
a dummy object is placed in the reaction tube while the dummy object is held by the holder in the steps (a) and (b);
the dummy object is placed in the reaction tube while the dummy object is held by the holder in the step (e); and
a metal or a metal compound deposited on a surface of the dummy object is removed by using the cleaning gas in the step (d).

9. The method according to claim 6, wherein the oxidation process gas contains steam and hydrogen gas, and wherein temperature of the oxidation process gas and steam/hydrogen partial pressure ratio between steam and hydrogen gas are controlled in the step (b) so that the silicon layer is oxidized and oxidation of the metal layer is suppressed.

10. The method according to claim 6, wherein:
the silicon layer is formed of polysilicon;
the metal layer is formed of tungsten or tungsten compound;
the oxidation process gas contains at least steam and hydrogen gas; and
the cleaning gas contains a compound gas containing at least chlorine or fluorine.

11. The method according to claim 6, wherein the cleaning gas contains oxygen gas and a compound gas containing chlorine.

12. The method according to claim 6, wherein pressure in the reaction tube in the step (d) is in a range of 133 Pa to 101 kPa.

13. The method according to claim 6, wherein pressure in the reaction tube is varied repeatedly in the step (d).
